(19) United States
(12) Patent Application Publication
(10) Pub. No.: US 2007/0026999 A1
(43) Pub. Date: Feb. 1, 2007

(54) Breaking plateaus multi-evaluation computerized weight-training log and system

(75) Inventors: Joseph Anthony Merolle, Oceanside, NY (US); Kara Melody Merolle, Oceanside, NY (US)

Correspondence Address: Joseph Merolle;Kara Merolle, 2021 Lincoln Avenue, Holbrook, NY, 11741, US

(73) Assignee: BREAKING PLATEAUS, L.L.C., Oceanside, NY (US)

(21) Appl. No.: 11/161,289

(22) Filed: Jul. 28, 2005

(51) Int. Cl. A63B 71/00; G01C 21/00

(52) U.S. Cl. 482/8; 701/213

(57) ABSTRACT

A pocket PC/desktop computer/PDA weight-training system designed to instantly calculate the domains of strength, power, endurance, work, aerobics, and body fat percentage. The system calculates the difference and percentage of change of each domain from weight-training session to session, reflecting a complete evaluation of overload. The system calculates the percentages of the user's 1-RM. When a weightlifting scheme grows ineffective, the user can choose another weight scheme related to their 1-RM, or they can change the exercises using a menu of complete exercises. The system also calculates the total rest days and days between trained body parts to evaluate recuperation cycles. The nutrition component calculates 47 nutrients, as the user marks servings of consumed foods. The user sets consumption goals, and the system reflects the difference of the goal and what was consumed. The aerobic/activity component gives the user a 30-day horizon analysis of muscle/fat gain or loss, based on the user's marked activity, calorie intake and the calculated basal metabolic rate.

### BREAKING PLATEAUS WEIGHT-TRAINING LOG (PAGE 1)

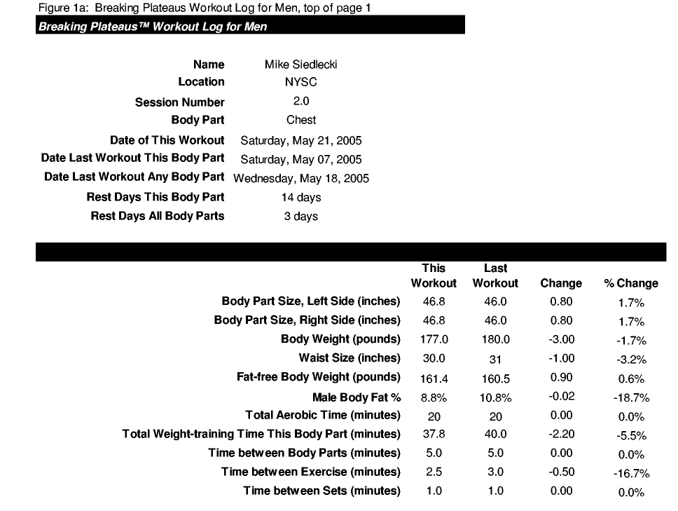

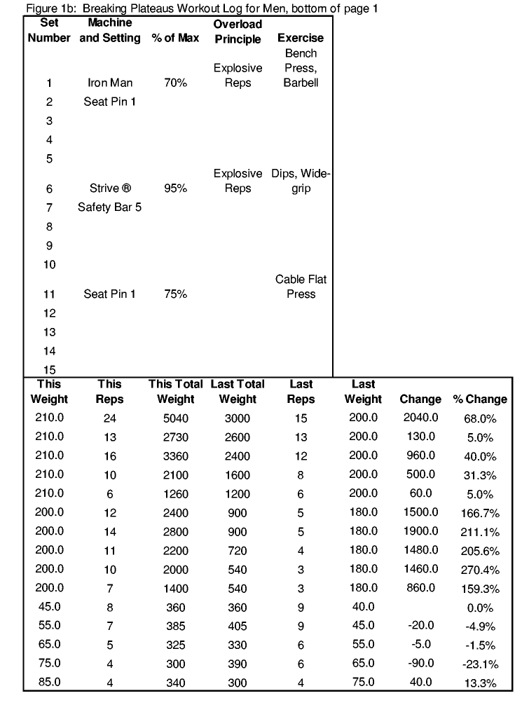

At the top left of the multi-evaluation computerized weight-training log (FIG. 1a. and 1b.), the user will see a field designated for his/her name. We included a “Name” field in case the user shares his/her computer with another athlete using this system.

Directly below the “Name” field is “Location.” Completing this section lets the user know years from now where the routine was performed. Every gym has unique characteristics, and the user cannot compare lifts at one gym to lifts at another gym. In the “Location” field, the user fills in the town and name of the gym.

Next, the user enters in the “Session Number” field, the number of times he/she performed this particular routine (FIG. 1a. and 1b.). In the “Body Part” field, the user lists the body part being trained. Labeling the body part trained enables the user to isolate the results (change and percentage of change) for each body part separately. The only time to record more than one body part on one log sheet is if the user supersets opposite body parts.

In the next three fields, the user records three different dates (FIG. 1a. and 1b.). The dates must be entered by typing the month, then the day (e.g., 6-12) in order for the formulas to work correctly. The first date is the date of the workout performed that day, “Date of This Workout.” The second date, “Date Last Workout This Body Part,” is a critical date. After inputting this date, the log calculates the number of days since the user trained the body part. Knowing the number of days between sessions helps the user determine his/her strength horizon line and recuperation cycle. The third date, “Date Last Workout Any Body Part,” helps the user determine the number of complete rest days. By filling in these three dates, the computerized log automatically calculates the number of rest days the user had for all body parts, and for the body part trained that day. The number of rest days automatically appears in the following fields and prevents overtraining and undertraining.

Body part tape measurements provide another means to mark the user's progress. The body part tape measurement of this workout corresponds to the date of the workout. The measurements are entered in the provided fields (“Body Part Size,” Waist Size,” “Forearm Size,” “Hip Size,” and “Wrist Size”). And the user's “Fat-free Body Weight” and “Body Fat %” is calculated by the log (FIG. 1a. and 1d.)

Next, the user enters the duration of time spent in aerobic activity in the “Total Aerobic Time” field (FIG. 1a. and 1d.).

The total weight-training time spent training the body part is entered in the “Total Weight-training Time This Body Part” field. This field works in conjunction with the “Total Weight” listed at the bottom of the log (FIG. 1a. and 1d.). This is a crude calculation of how much power was generated during the workout or the number of pounds per minute lifted during the workout. In following sessions of this routine, the user will also be able to see a change and a percentage of change for pounds per minute generated during the workout.

In the “Time between Body Parts,” “Time between Exercises,” and “Time between Sets” fields that follow, the appropriate times are listed by the user in minutes (FIG. 1a and 1d.). The goal of the user should be to increase the number of lifts in the same amount of time or less time as the original workout. If the user takes more time between sets and the overall workout, it is difficult to decipher whether the increased performance was due to muscle growth or more rest. For this reason, it is critical to record the time between sets, time between exercise, and time between body parts. Without these figures, the percentage of change is meaningless.

The “Change” and “% Change” fields are listed to the right of the fields mentioned (FIG. 1b.). When the user records his/her data for “This Workout” and the “Last Workout” in the appropriate columns (assuming both workouts were identical for the body part(s) trained, except for the weight and repetitions lifted, and time factor) the “Change” and “% Change” data are provided for both of the workouts. The user instantly sees how his/her workout compared to the previous workout and resulting physiological changes (e.g., body weight, body fat percentage, fat-free body weight, strength, power, endurance, and work).

In the “Machine and Setting” field, the user labels (either manually or using the provided pull-down menu) the machine used (FIG. 1b.). Let's assume the user starts with Military Presses on a Nautilus® machine to train the deltoids (shoulders), and the user takes two minutes in beween sets, with a seat setting of 4. After he/she recovers, in x amount of days, testing the body under all of the former variables gives an accurate comparison between the two workouts. Let's further assume that after executing this routine several times (with plenty of time for recuperation and growth), the user is unable to produce a significant positive percentage of change. Then, it is time to try a different routine. The change could be switching the machine, choosing free weights, modifying the time beween sets, changing the order of the exercise or body parts worked, or adjusting the amount of weight, and the range-of-motion.

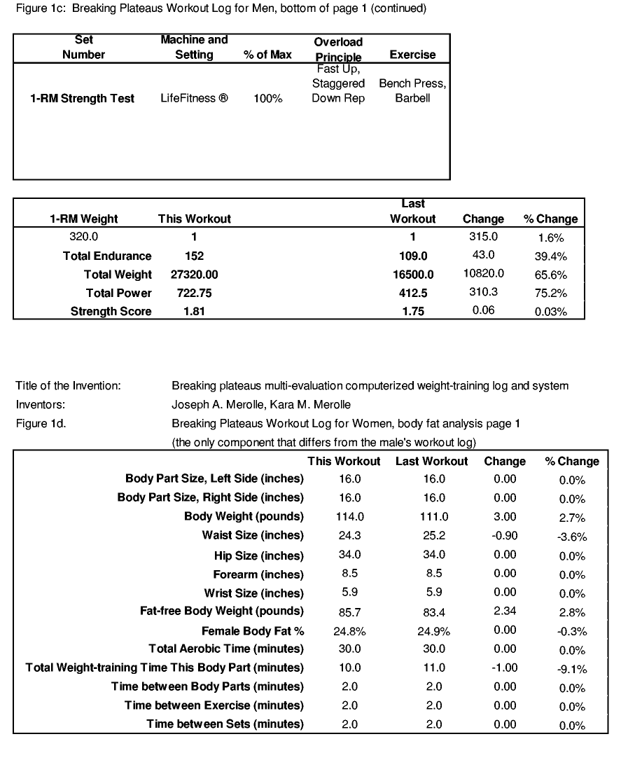

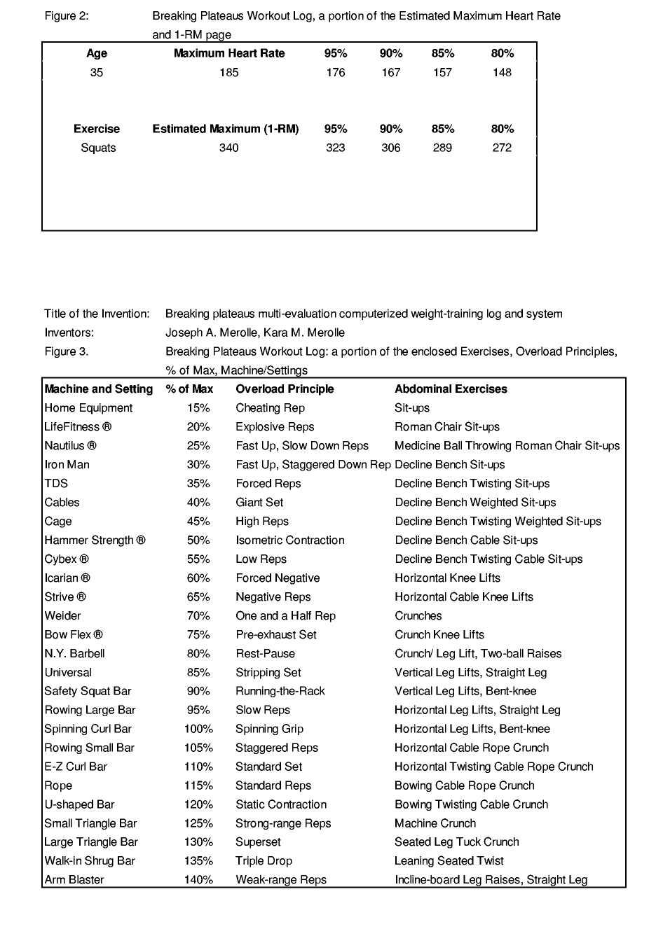

To prevent the user from stagnation and using the same old weight scheme (when configuring future routines) it is a good idea to record approximately the percentage of his/her one-rep max (the maximum weight the athlete can lift in one repetition, 1-RM) in the “% of Max” field (FIG. 1b.). The percentage of max can be entered either manually or using the provided pull-down menu. Adjacent to the “Exercise” Field on page 2 of the Training Log, is the “Estimated Maximum” column (FIG. 2). The athlete will be able to get a quick percentage of his/her 1-RM by entering the 1-RM in this field. If the athlete does not know his/her max for a particular exercise, estimation can be made. An exact science is not necessary here. If the user performs high repetitions, he/she performs a low percentage of his/her max. If he/she performs fewer repetitions, he/she uses a higher percentage of his/her max.

In the “Overload Principle” field (FIG. 1b.), the user identifies (manually or via the provided pull-down menu) the specific overload style being performed. The user inputs specific exercise(s) performed during the workout in the “Exercise” field. The exercises either can be typed or entered using the provided pull-down menu.

The user records the weight lifted for the initial workout in the “This Weight” column (FIG. 1b.). The user inputs the number of repetitions performed during the initial workout in the “This Reps” column. The second time the user performs the identical routine, the information in the “This Weight” and “This Reps” columns is moved to the “Last Weight” and “Last Reps” columns, respectively. The data from the second workout (session two) is recorded in the “This Weight” and “This Reps” columns. After the user inputs the information for session two, the “Change” and “% Change” between the two workouts will automatically appear. Instantly, the log provides the change and percentage of change for each set and each exercise, enabling the user to determine whether the routine provided enough overload to produce growth.

“Change” and “% Change” data is provided for body part size (right and left side), body weight, waist size, fat-free body weight, body fat percentage, total aerobic time, total weight-training time for the body part, time between body parts, time between exercises, time between sets, this weight/this reps compared to last reps/last weight, total endurance, total weight lifted (work), total power, and strength score, as seen in FIG. 1a., 1b., and 1c.

### Breaking Plateaus Weight-training Log (Page 2)

On page 2 of the computerized weight-training log, “Estimated Maximum,” the user can input his/her age in the “Age” field (FIG. 2). Doing so causes the maximum heart rate and percentages of maximum heart rate (from 25 to 100%) to appear. Below the percentages of maximum heart rate, the user can enter exercise(s) in the “Exercise” field and the one-rep max in the “Estimated Maximum (1-RM)” field. Doing so produces the percentages of the 1-RM (from 25 to 95%) to appear in the adjacent columns. The athlete can estimate what percentage of his/her max is being lifted. If the athlete consistently works with the same weight scheme, he/she will plateau. When negative numbers appear in the “Change” and “% Change” columns (FIG. 1a. through 1d.), the user should include a different weight scheme when training that body part.

### Breaking Plateaus Weight-training Log (Page 3)

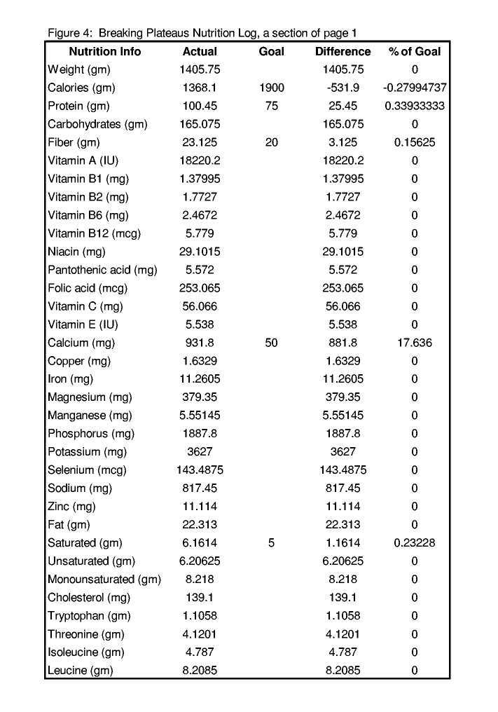

The third page of the multi-evaluation computerized weight-training log includes a list of Machines and Settings, Overload Principles, % of Max, and Exercises for 11 body parts (FIG. 3). The information listed on this page is also found in pull-down menus on page 1 in the “Machine and Setting,” “% of Max,” “Overload Principle,” and “Exercise” columns.

### Breaking Plateaus Computerized Nutrition Log

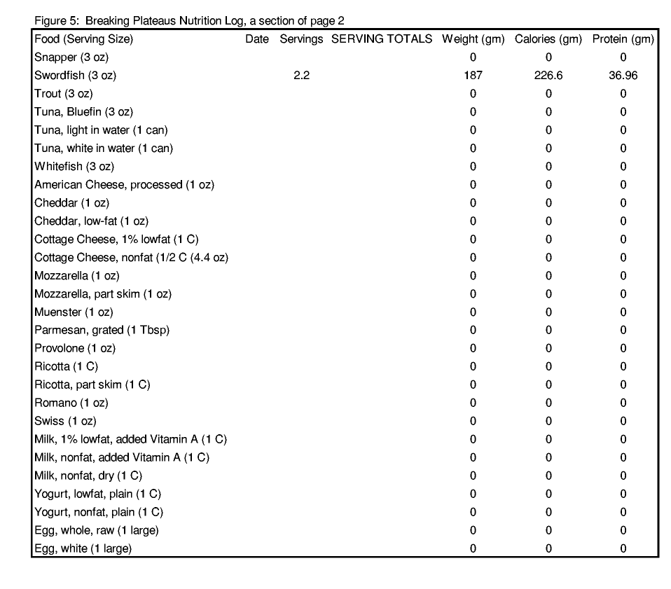

The user tweaks the servings, according to the weight in grams of the food, so the log reflects the accurate amount of nutrients eaten within the day. For example, let's say the user's bodybuilding diet requires 36 grams of protein per meal, and he/she decides to eat fish to meet this requirement. Adjusting the servings of swordfish on the “Nutrition Data” page to 2.2, reflects that 187 grams of swordfish meet the required 36 grams of protein (FIG. 5). This method can be used for all foods listed in the log. As the user marks the servings and saves the data on the “Nutrition Data” page throughout the day, he/she can instantly see the total nutrients on the “Nutrition Goal” page (FIG. 4) in the “Actual” column for the servings and foods eaten.

Not only does the nutrition log track the user's daily nutritional intake, it also allows the user to set nutritional goals. For example, if the athlete aims to consume 184 grams of protein during the day, 184 is inputted in the “Goal” field located on the “Nutrition Goal” page (FIG. 4). As the user enters the food consumed throughout the day on the “Nutrition Data” page (FIG. 5), the amount of 47 nutrients are calculated and appear at the bottom of the page, as well as on the “Nutrition Goal” page. The user can instantly see how his/her food intake compares to his/her nutritional goals. The “Nutrition Goal” page (FIG. 4) lists a “Nutrition Info” column (47 nutrients, including calories, fat, protein, and carbohydrates), an “Actual” column (the actual numerical amount consumed per day), a “Goal” column (user defined for each nutrient, if needed), a “Difference” column (the difference between the “Actual” and “Goal”), and a “% of Goal” column (the percentage in which the user missed or achieved his/her nutritional goals). This feedback is indispensable, especially when setting fat-reduction goals or targeting key vitamins and minerals.

We included basic whole foods and protein powders, since these foods comprise most of a competitive bodybuilder's diet. However, I teach the user how to add additional foods, so he/she can tailor the log to meet food consumption.

After the user determines the nutritional values of the food, at the bottom of the “Nutrition Data” page (after Supplements), the food name can be added in the white field in the “Food” column (FIG. 5). To the far right (in the same row), the nutritional content for one serving is entered in the white fields. For accurate calculations, as much nutritional information as possible is inputted, by the user, under the applicable headings (e.g., Calories, Protein, Carbohydrates).

After entering the data, the log accepts the information (after hitting “Save”) and calculates the nutritional content based on the number of servings chosen. For instance, if the user-defined food is 200 calories and 30 grams of protein, and he/she consumes six servings, the log will reflect 1200 calories and 180 grams of protein.

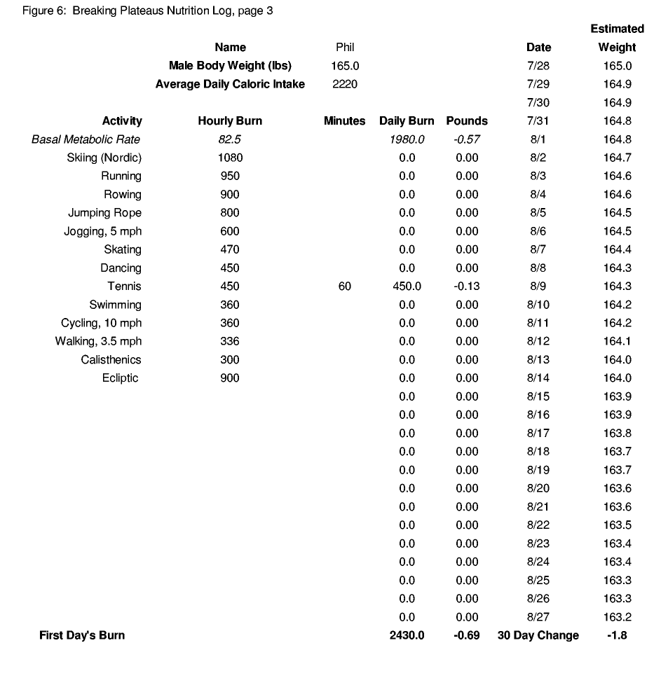

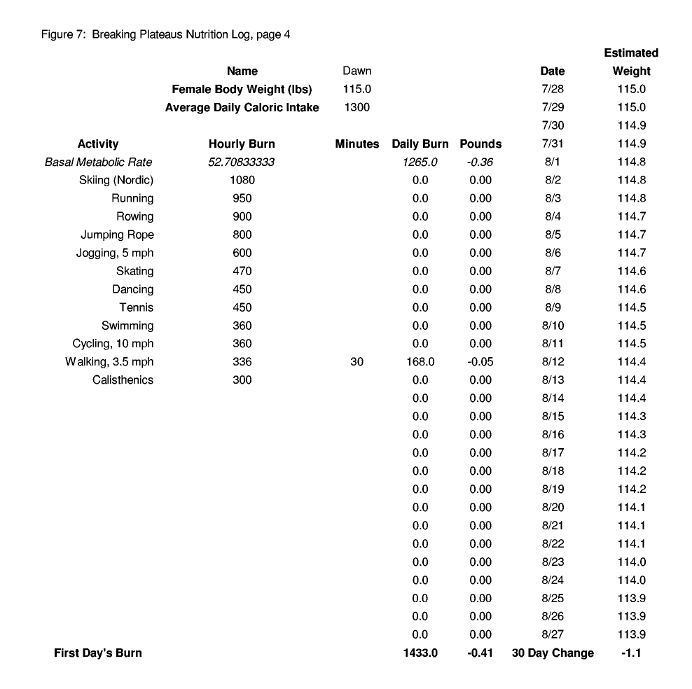

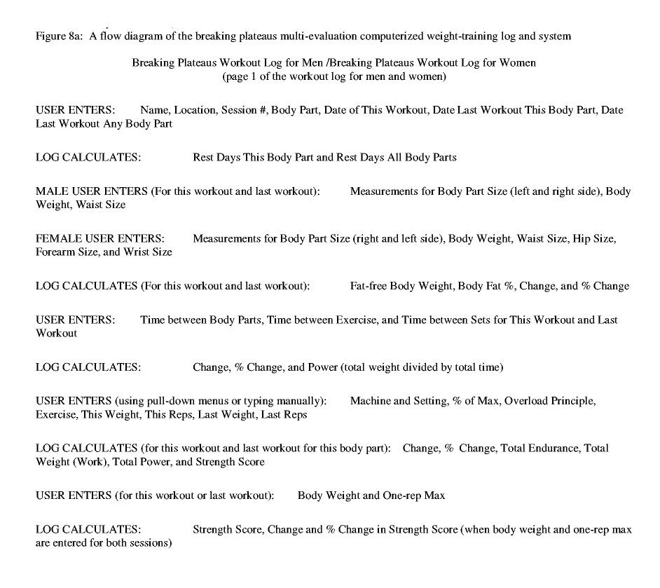

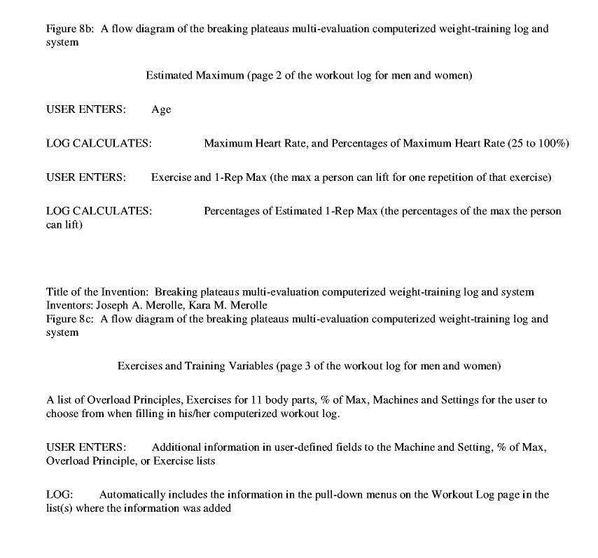

On the “Basal Metabolic Rate for Men” (page 3) and “Basal Metabolic Rate for Women” (page 4) pages of the Nutrition Log is a system devised to help the user balance food intake with training activities (FIG. 6 and 7). After inputting his/her body weight, an estimated daily caloric intake appears and shows the number of calories needed to consume in order to maintain the his/her current body weight while resting (basal metabolic rate). The log not only gives the user a daily basal metabolic rate, but the hourly rate of calories burned while resting. In addition, the user can enter the number of calories actually consumed per day in the “Average Daily Caloric Intake” field. Afterward, a 30-day horizon line is provided (what the user can expect to gain or lose at that level of activity and food consumption after 30 days). Activities (e.g. running, skiing, swimming) are listed under the basal metabolic rate, along with an estimated “Hourly Burn” for each activity. The user can enter the type of activity and minutes, and adjustments are made in his/her 30-day horizon line. The user can input additional activities and hourly burn in the fields provided in the bottom half of the page (FIG. 6 and 7). After inputting body weight, daily caloric intake, and minutes of activity, the log gives the user a 30-day horizon line of how many pounds he/she can expect to gain or lose. The basal metabolic rate component and the 30-day progression horizon line sets this nutrition log apart from other electronic nutrition logs.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

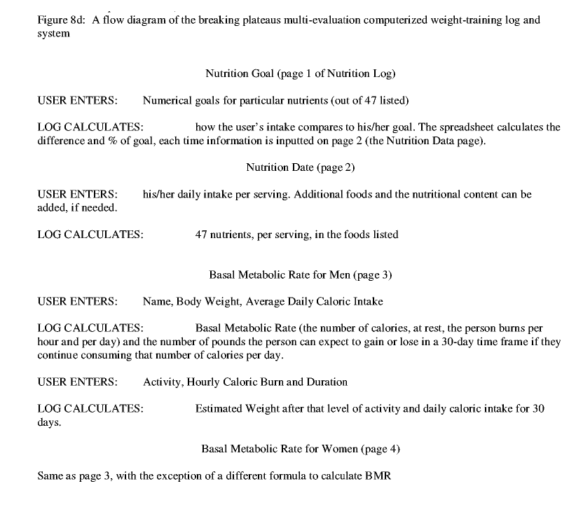

20. The invention claimed is a method of evaluating the productivity of a fitness regimen, which comprises a computerized weight-training log and computerized nutrition log that informs the particular user of changes (progress or lack thereof) in the particular user's data from workout to workout (FIG. 8).

21. We claim the method of claim 1 wherein the computerized weight-training log (FIG. 1a. and 1b.) assists the particular user in the calculations of: recuperation time, change in lean body weight, change in body-fat percentage, change in aerobic activity, change in the amount of time to perform the routine, change in the amount of time between the sets, exercises and body parts trained, and changes in endurance, strength, weight lifted and power compared to the baseline workout (based on the exercise data the particular user enters into the log).

22. We claim the method of claim 1 wherein the computerized weight-training log (FIG. 1a. and 1b.) assists the particular user in the calculations of: the percentage of change in lean body weight, percentage of change in body-fat level, percentage of change in aerobic activity, percentage of change in the amount of time to perform the routine, percentage of change in the amount of time between the sets, exercises and body parts trained, and the percentage of change in endurance, strength, weight lifted and power compared to the baseline workout (based on the exercise data the particular user enters into the log).

23. We claim the method of claim 1 wherein the computerized weight-training log comprises: pull-down menus for the “Machine and Setting” column, “% of Max” column, “Overload Principle” column and “Exercise” column to assist the particular user in the adjustment of the new workout based on prior performance data (FIG. 1a., FIG. 1b., and FIG. 3).

24. We claim the method of claim 1 wherein the computerized nutrition log (FIG. 5) provides the amount of 47 nutrients per serving in over 200 whole foods that provides the particular user with nutritional data regarding the user's food consumption and relays how the nutritional data compares to the user's nutritional goals (based on the amount of food servings consumed and entered into the nutrition log by the particular user)

25. We claim the method of claim 1 wherein the computerized nutrition log calculates the particular user's basal metabolic rate, the amount of calories burned during specific activities and the user's estimated weight loss over a 30-day period.

26. We claim the method of claim 1 wherein the computerized weight-training log calculates percentages of the particular user's maximum lift (1-RM).

27. We claim the method of claim 1 wherein the computerized weight-training log calculates the particular user's maximum heart rate and percentages of the user's maximum heart rate.

28. We claim the method of claim 5 wherein the computerized nutrition log provides the particular user with a section to add food and nutrition values per serving within the range of the 47 nutrients listed to include in the user's nutritional evaluation.
